(19) United States
(12) Patent Application Publication
(10) Pub. No.: US 2001/0013934 A1
(43) Pub. Date: Aug. 16, 2001

(54) SEISMIC SENSOR WITH INTERFEROMETRIC SENSING APPARATUS

(76) Inventors: MALCOLM PAUL VARNHAM, HAMPSHIRE (GB); ERHARD LOTHAR EDGAR KLUTH, HAMPSHIRE (GB)

Correspondence Address: TIM COOK, BRACEWELL & PATTERSON, L.L.P., P O Box 61389, HOUSTON, TX, 77208-1389, US

(21) Appl. No.: 09/193,761

(22) Filed: Nov. 17, 1998

(30) Foreign Application Priority Data
Nov. 18, 1997 (GB) 9724199.6
Dec. 1, 1997 (GB) 9725207.6

(51) Int. Cl. G01B 9/02

(52) U.S. Cl. 356/478; 356/480

(57) ABSTRACT

An apparatus for interferometric sensing comprises a first broadband switched optical source, a first matched interferometer, a plurality of first sensing interferometers, and a detector. The first matched interferometer contains a first phase modulator. The optical path length difference in each of the first sensing interferometers is approximately equal to the optical path length difference in the first matched interferometer Each of the first sensing interferometers returns an optical interference signal to the detector at a substantially different wavelength The first broadband switched optical source is switched so as to emit optical radiation at wavelengths corresponding to each of the first sensing interferometers at different times.

### FIELD OF THE INVENTION

This invention relates to interferometric sensing apparatus. In particular it relates to the configuration particularly suited to an efficient multiplexing arrangement for hydrophone arrays.

### BACKGROUND OF THE INVENTION

There is a demand in the oil and gas industry to improve the hit rate of locating recoverable reserves, and for increasing the percentage of oil and gas recovered from reservoirs. This has resulted in the demand for improvements in the quality of seismic surveys and in a demand for in-reservoir fluid-imaging techniques. Both these requirements demand large numbers of sensors networked together.

Similar requirements in defense applications have been met using time-division multiplexing techniques, involving interrogating a number of hydrophone elements using a single pulse of light. The technique relies on the fact that for each hydrophone along the path part of the pulse energy will be modified by the hydrophone and reflected. This results in a series of reflected light pulses returning to a detector at different times from the separate hydrophone elements. A limitation with this approach is that bandwidth is limited because of aliasing effects, which also restricts dynamic range. A further problem is that the number of elements addressable by a single source is relatively limited, leading to a fairly large number of expensive electro-optic sources required in the total system.

Apparatus suitable for the simultaneous acquisition of high-bandwidth information in very-long arrays was disclosed in a previous patent application GB2284256A. Wavelength division multiplexing was used in this apparatus such that hydrophone arrays could be interrogated with broadband light, and the information from each hydrophone returned at unique wavelengths. These wavelengths were separated and routed to different detectors. This apparatus has the drawback in that it utilizes a very-large number of detectors—one per hydrophone element. Nevertheless, it is probably the only way to achieve very-high bandwidth (500 kHz) interrogation of very-short (1 m) hydrophones. The apparatus is probably not cost-effective for very-large hydrophone arrays where the bandwidth requirement is relatively modest.

Wavelength-addressable interferometers containing fiber Bragg grating pairs as reflectors are particularly attractive—particularly if ways can be found to eliminate, or dramatically reduce, cross-talk between hydrophones. Such cross-talk is inherent in many architectures.

Conventional electrical seismic streamers contain hydrophones which are grouped together to reduce tow noise. Such groups are typically 12.5 m long and may contain 24 hydrophones. Optical hydrophone arrays can be constructed in a similar fashion, combining the outputs of groups of hydrophones in signal processing electronics. A more cost-effective solution is to replace each hydrophone group with a single hydrophone constructed in a linear fashion.

Streamers based on large arrays of optical hydrophones should preferably be cost-effective compared to conventional electronic arrays. Many hundreds of hydrophones are required in a single streamer and the technical specifications are demanding. There are large cost benefits associated with increasing the numbers of hydrophones per optical fiber in the streamer. Reducing the numbers of fibers in the streamer to 16 or less is particularly advantageous in that it reduces the complexities involved in joining lengths of streamer together. However, reducing the numbers of fibers in the streamer implies that there needs to be more hydrophones per fiber in the streamer which can lead to cross-talk between hydrophones.

### SUMMARY OF THE INVENTION

An aim of the present invention is to provide an efficient multiplexing arrangement for interferometric sensor arrays. This has particular relevance for seismic streamers comprising very-large arrays of optical hydrophones where the requirement of low cross-talk between the hydrophones exists and where the potential reduction of cable size and complexity offer important improvements.

Accordingly in one non-limiting embodiment of the present invention, there is provided apparatus for interferometric sensing, which apparatus comprises a first broadband switched optical source, a first matched interferometer, a plurality of first sensing interferometers, and a detector: the first matched interferometer being such that it contains a first phase modulator; the apparatus being such that the optical path length difference in each of the first sensing interferometers is approximately equal to the optical path length difference in the first matched interferometer; the first sensing interferometers being such that each returns an optical interference signal to the detector at a substantially different wavelength; and the apparatus being such that the first broadband switched optical source is switched so as to emit optical radiation at wavelengths corresponding to each of the first sensing interferometers at different times.

The optical path length difference of the first sensing interferometers should be equal to the optical path length difference in the first matched interferometer to within the coherence length of the optical interference signal returned to the detector by each of the first sensing interferometers.

The first phase modulator may be a frequency shifter.

At least one of the first sensing interferometers may be a fiber optic sensing interferometer containing at least one optical fiber Bragg grating.

The fiber optic sensing interferometer may contain an optical fiber Bragg grating at each end of the fiber optic sensing interferometer. The optical fiber Bragg gratings may be chirped in opposite directions.

The first sensing interferometers may be optical fiber hydrophones. The optical fiber hydrophones may be constructed by winding an optical fiber around a compliant member and bonding the optical fiber to the compliant member. The optical fiber hydrophone may be constructed from an optical fiber with a compliant coating.

The apparatus may contain a depolarizer. The depolarizer may be a Lyott depolarizer, for example a Lyott depolarizer fabricated out of polarization maintaining optical fiber.

The apparatus may contain an optical circulator to direct optical radiation to the first sensing interferometers and to direct light returning from the first sensing interferometers to the detector.

The apparatus may contain an optical isolator to isolate the first broadband switched optical source from reflections.

The apparatus may contain an optical amplifier to improve signal to noise ratio.

The apparatus may contain an additional first sensing interferometer which reflects at substantially the same wavelength as one of the first sensing interferometers and where the path length difference in the additional first sensing interferometer is substantially equal to the path length difference in the first matched interferometer, the apparatus being such that the optical interference signals from the additional first sensing interferometer is not incident on the detector at the same time as the optical interference signal returning from any of the first sensing interferometers so that the first sensing interferometers and the additional first sensing interferometer can be interrogated using time division multiplexing.

The first broadband switched optical source may contain a light emitting diode, a superfluorescent fiber source, or a super-luminescent diode.

The first broadband switched optical source may contain at least one acousto-optic tunable filter.

The first broadband switched optical source may be scanned in wavelength.

The first broadband switched optical source may be stepped in wavelength either monotonically or otherwise.

The first broadband switched optical source may contain first and second acousto-optic tunable filters, in which the first acousto-optic tunable filter has its first sidebands substantially at the wavelength corresponding to the first wavelength zeros of the second acousto-optic tunable filter.

In a first aspect of the invention, the apparatus includes a second broadband switched optical source, a second matched interferometer, a coupler, and a plurality of second sensing interferometers: the coupler being such that it combines light from the first broadband switched optical source and the second broadband switched optical source; the second matched interferometer being such that it contains a second phase modulator; the apparatus being such that the optical path length difference in the second sensing interferometers is approximately equal to the optical path length difference in the second matched interferometer; the second sensing interferometers being such that each returns an optical interference signal to the detector at a different wavelength; and the apparatus being such that the second broadband switched optical source is switched so as to emit optical radiation at wavelengths corresponding to each of the second sensing interferometers at different times.

The path length difference of the second matched interferometer may be different from the path length difference of the first matched interferometer such that the visibility of interference signals from the first sensing interferometers interrogated by optical radiation from the second matched interferometer is very low. The modulation applied by the first phase modulator may be different from the modulation applied by the second phase modulator. Readout electronics may utilize the unique identifying characteristic of each phase modulator in order to demultiplex the signals from the first sensing interferometers from the signals from the second sensing interferometers.

### BRIEF DESCRIPTION OF THE DRAWINGS

Embodiments of the invention will now be described solely by way of example and with reference to the accompanying drawings in which:

FIG. 1 shows interferometric sensing apparatus including a first broadband switched optical source;

FIG. 2 shows an optical fiber sensing interferometer containing Bragg gratings;

FIG. 3 shows a hydrophone element constructed by winding an optical fiber around a compliant member;

FIG. 4 shows interferometric sensing apparatus containing an optical isolator, a depolarizer and an optical circulator;

FIG. 5 shows interferometric sensing apparatus containing a polarization diversity receiver;

FIG. 6 shows interferometric sensing apparatus containing additional first sensing interferometers;

FIG. 7 shows a broadband switched optical source containing an acousto-optic tunable filter;

FIG. 8 shows a broadband switched optical source containing first and second acousto-optic tunable filters;

FIG. 9 shows the spectral response of the first and second acousto-optic tunable filters;

FIG. 10 shows a broadband switched optical source containing an optical amplifier;

FIG. 11 shows interferometric sensing apparatus containing four wavelength-switching gain blocks;

FIG. 12 shows interferometric sensing apparatus containing polarization beam splitters;

FIG. 13 shows interferometric sensing apparatus containing eight sensing subsystems each containing four sensing arrays;

FIG. 14 shows interferometric sensing apparatus being deployed;

FIG. 15 shows a preferred timing sequence for interrogating individual sensing interferometers;

FIG. 16 shows a technique to reduce source noise;

FIG. 17 shows a broadband switched optical source configured as a ring;

FIG. 18 shows interferometric sensing apparatus utilizing switches in the readout electronics;

FIG. 19 shows interferometric sensing apparatus utilizing switches in the readout electronics and polarization beam splitters;

FIG. 20 shows interferometric sensing apparatus utilizing switches in the readout electronics and four sensing arrays per sensing subsystem;

FIG. 21 shows interferometric sensing apparatus utilizing a wavelength division multiplexer;

FIG. 22 shows interferometric sensing apparatus utilizing a wavelength division multiplexer and polarization beam splitters;

FIG. 23 shows interferometric sensing apparatus utilizing a wavelength division multiplexer and four sensing arrays per sensing subsystem;

FIG. 24 shows interferometric sensing apparatus utilizing acousto-optic tunable filters in the readout electronics;

FIG. 25 shows interferometric sensing apparatus utilizing acousto-optic tunable filters in the readout electronics and polarization beam splitters; and

FIG. 26 shows interferometric sensing apparatus utilizing acousto-optic tunable filters in the readout electronics and four sensing arrays per sensing subsystem.

### DETAILED DESCRIPTION OF PREFERRED EMBODIMENTS

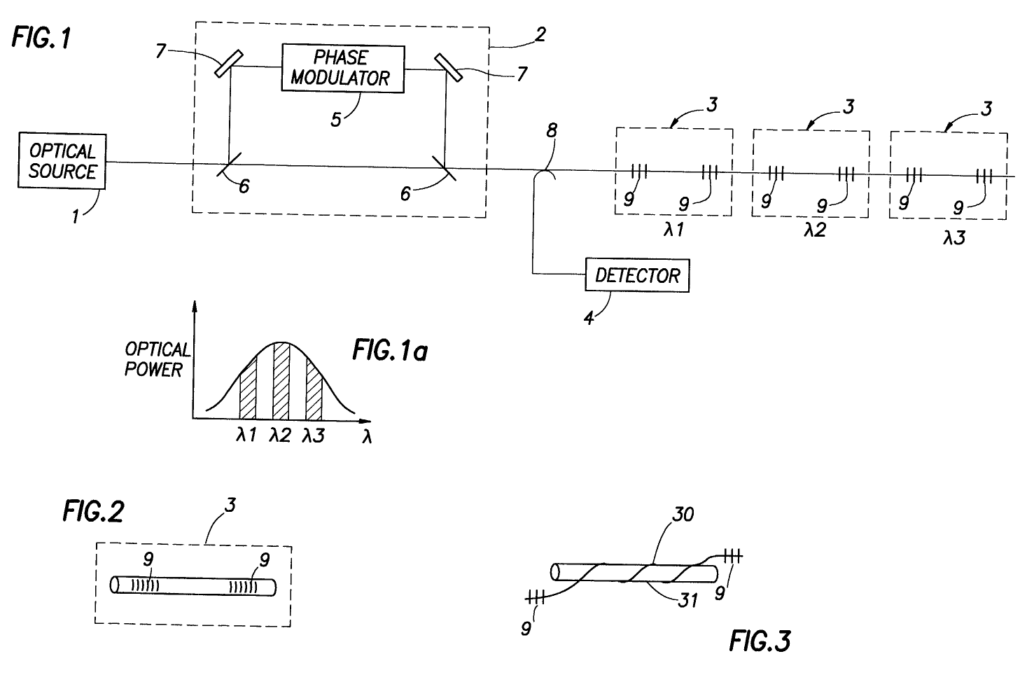

With reference to FIG. 1, there is provided apparatus for interferometric sensing comprising a first broadband switched optical source 1, a first matched interferometer 2, a plurality of first sensing interferometers 3, and a detector 4: the first matched interferometer 2 being such that it contains a first phase modulator 5; the apparatus being such that the optical path length difference in each of the first sensing interferometers 3 is approximately equal to the optical path length difference in the first matched interferometer 2; the first sensing interferometers 3 being such that each returns an optical interference signal to the detector 4 at a substantially different wavelength; and the apparatus being such that the first broadband switched optical source 1 is switched so as to emit optical radiation at wavelengths corresponding to each of the first sensing interferometers 3 at different times.

The first matched interferometer 2 is shown in bulk optics form constructed from half-wave plates 6 and mirrors 7.

A coupler 8 is shown which directs optical radiation from the first broadband switched optical source 1 to the first sensing interferometers 3, and directs optical radiation from the first sensing interferometers 3 to the detector 4.

The phase modulator 5 may be a frequency shifter such as an acousto-optic modulator or a fiber-optic frequency shifter. Alternatively, phase modulators constructed out of integrated optics or other electro-optic crystals can be used.

The first sensing interferometers 3 are shown constructed using optical fiber Bragg gratings 9. The optical path length difference in the first sensing interferometers 3 is twice the optical path length between the two optical fiber Bragg gratings 9. This is because the optical interference signal returned by each of the first sensing interferometers 3 has two components (one from each optical fiber Bragg grating 9) separated by an optical path length difference equal to the round-trip optical path length between the two optical fiber Bragg gratings 9. The optical fiber between the two optical fiber Bragg gratings 9 may be polarization maintaining optical fiber in order to reduce polarization fading in the apparatus.

The optical fiber Bragg gratings 9 reflect light at wavelengths which can be defined during manufacture. Thus each of the first sensing interferometers 3 can be designed such that each returns an optical interference signal to the detector 4 at a different wavelength. The spectral width of the reflected light from each of the first sensing interferometers 3 may be in the range of 0.1 nm to 10 nm. The wavelength spacing between different first sensing interferometers 3 may be chosen such that the cross-talk between first sensing interferometers 3 is reduced to an acceptable level.

The optical fiber Bragg gratings 9 at either end of the fiber-optic sensing interferometers may be chirped in opposite directions as shown in FIG. 2.

The first sensing interferometers 3 may be optical fiber hydrophones. The optical fiber hydrophones may be constructed as shown in FIG. 3 by winding an optical fiber 30 around a compliant member 31 and bonding the optical fiber 30 to the compliant member 31. Alternatively, the optical fiber hydrophones may be constructed by winding optical fiber onto mandrels.

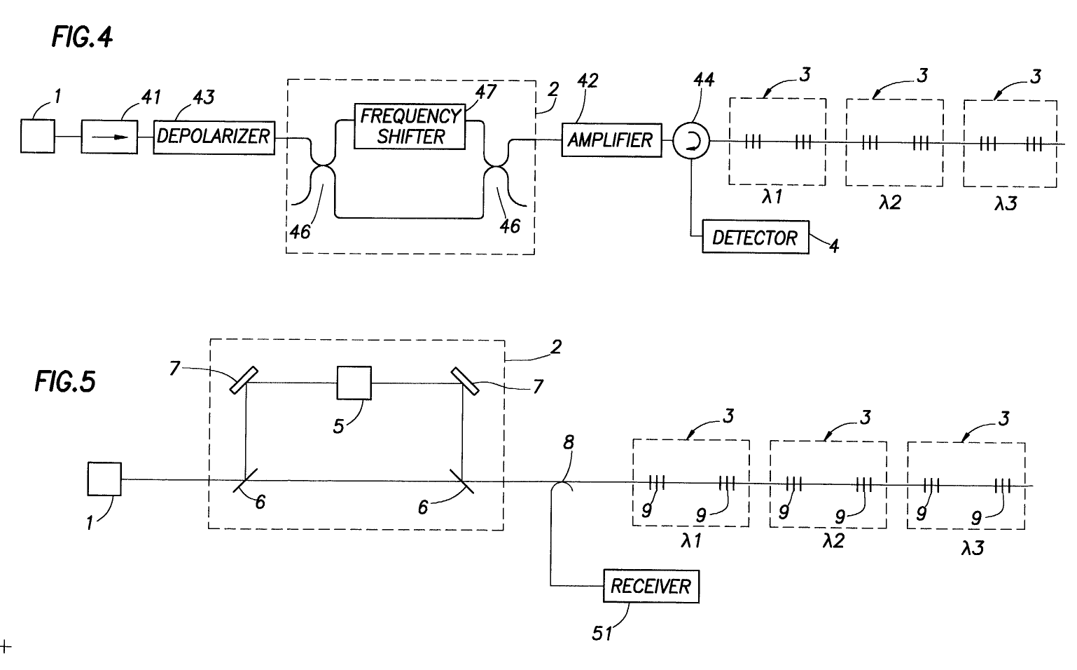

FIG. 4 shows an embodiment of the invention which includes an optical isolator 41 to isolate the first broadband switched optical source 1 from reflections, an optical amplifier 42 to improve signal to noise ratio, a depolarizer 43 to reduce polarization fading, and an optical circulator 44 to direct optical radiation to the first sensing interferometers 3 and to direct light returning from the first sensing interferometers 3 to the detector 4. The first matched interferometer 2 is shown constructed using optical fiber couplers 46 and a frequency shifter 47. The optical fiber within the first matched interferometer 2 may be polarization maintaining fiber in order to reduce polarization fading in the apparatus. Polarization controllers may be provided within the first matched interferometer 2.

The depolarizer 43 may be any convenient depolarizer such as a Lyott depolarizer. For fiber-optic sensing applications, a Lyott depolarizer can be conveniently constructed using two lengths of highly-birefringent optical fiber spliced together at 45 degrees, one length having twice the retardation of the other length. It is important that the Lyott depolarizer depolarizes the light incident on the detector 4 from each of the first sensing interferometers 3. This is particularly important because the optical radiation returned from the first sensing interferometers 3 will have a longer coherence length than the optical radiation emitted by the first broadband switched optical source 1.

The frequency shifter 47 may be an acousto-optic modulator or a fiber-optic frequency shifter.

FIG. 5 shows an embodiment of the invention in which the apparatus contains a polarization diversity receiver 51 such as is described by N. J. Frigo, A. Dandridge and A. B. Tveten in the paper entitled “Technique for elimination of polarization fading in fiber interferometers”, Electronics Letters, Apr. 12, 1984. The polarization diversity receiver 51 overcomes polarization-induced fading within the apparatus.

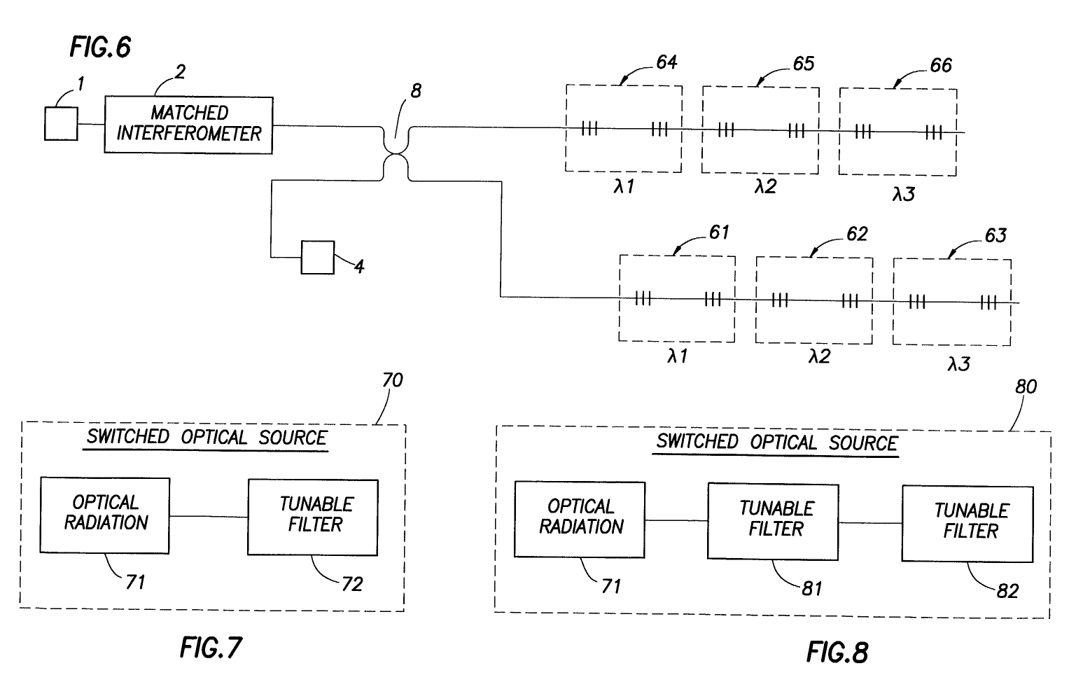

FIG. 6 shows an embodiment of the invention in which the apparatus contains additional first sensing interferometers 61, 62 and 63. Each additional first sensing interferometer 61, 62 and 63 returns optical interference signals to the detector 4 at substantially different wavelengths. Each additional first sensing interferometer 61, 62 and 63 returns optical interference signals to the detector 4 at substantially the same wavelength as one of the first sensing interferometers 64, 65 and 66. The path length difference in each additional first sensing interferometer 61, 62 and 63 is substantially equal to the path length difference in the first matched interferometer 2. The apparatus is designed such that the optical interference signals from any of the additional first sensing interferometers 61, 62 and 63 are not incident on the detector at the same time as the optical interference signals returning from any of the first sensing interferometers 64, 65 and 66 so that the signals returning from the first sensing interferometers 64, 65 and 66 can be separated from the signals returning from the additional first sensing interferometers 61, 62 and 63 in the time domain.

FIG. 7 shows a design of a broadband switched optical source 70 which contains a broadband source of optical radiation 71 and an acousto-optic tunable filter 72. The broadband source of optical radiation 71 may be a light emitting diode, a superfluorescent fiber source, or a super-luminescent diode. It may be preferable to use more than one acousto-optic tunable filter 72 in order to reduce the spectral bandwidth of the emitted optical radiation from the broadband switched optical source 70.

A problem in certain applications with the design of the broadband switched optical source 70 shown in FIG. 7 is that the optical spectrum may contain sidebands in addition to the desired broadband optical radiation. Currently available acousto-optic tunable filters have sidebands which contain approximately 5% of the throughput optical power. Such sidebands may lead to cross-coupling of the measurements between one or more of the first sensing interferometers 3. It may therefore be preferable to design the array of the first sensing interferometers 3 such that crosstalk due to sidebands from the broadband switched optical source 70 are minimized by ensuring that the wavelength spacing of the first sensing interferometers 3 does not correspond to the wavelength offset of the sidebands.

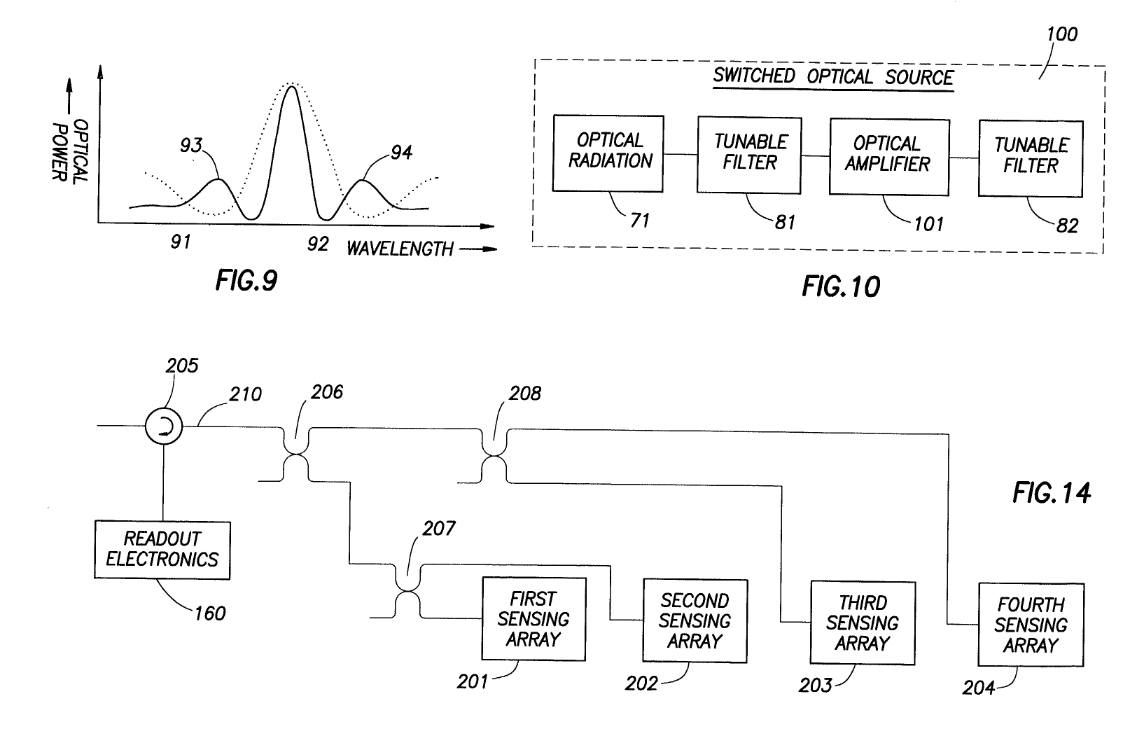

FIG. 8 shows a broadband switched optical source 80 which contains a first acousto-optic tunable filter 81 and a second acousto-optical tunable filter 82. The spectral outputs of the first acousto-optic tunable filter 81 and the second acousto-optic tunable filter 82 are shown in FIG. 9. The first acousto-optical tunable filter 81 has its first sidebands 93 and 94 at substantially the wavelength corresponding to the first wavelength zeros 91 and 92 of the second acousto-optic tunable filter 82. The result is a reduction of the optical power outside the spectral width of the broadband switched optical source 80.

FIG. 10 shows a design of a broadband switched optical source 100 which contains an optical amplifier 101. The optical amplifier 101 may be an optical fiber amplifier such as an erbium-doped optical fiber amplifier. The broadband switched optical source 100 emits more optical power than the broadband switched optical source 80 owing to the incorporation of the optical amplifier 101. Saturation of the gain medium within the optical amplifier 101 can be utilized in order to reduce the relative proportion of optical power emitted outside the wavelength range selected by the first and second acousto-optic tunable filters 81 and 82.

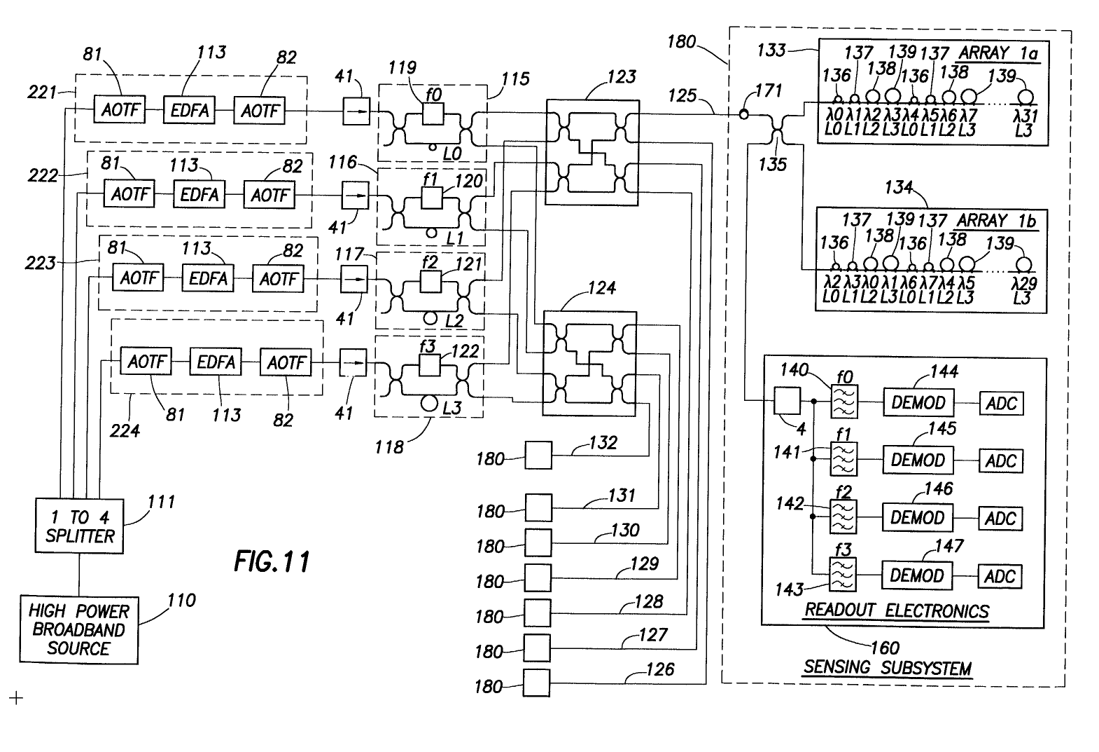

FIG. 11 shows an embodiment of the invention. The output power from a high-power broadband source 110 is divided into four outputs by a splitter 111 and is then directed into first, second, third and fourth wavelength-switching gain blocks 221, 222, 223 and 224, each comprising the first acousto-optical tunable filter 81, the second acousto-optical tunable filter 82 and an erbium-doped fiber amplifier 113. The output of the first wavelength-switching gain block 221 is connected via the optical isolator 41 to a first matched interferometer 115, the output of the second wavelength-switching gain block 222 is connected via the optical isolator 41 to a second matched interferometer 116, the output of the third wavelength-switching gain block 223 is connected via the optical isolator 41 to a third matched interferometer 117 and the output of the fourth wavelength-switching gain block 224 is connected via the optical isolator 41 to a fourth matched interferometer 118.

The outputs of the first, second, third and fourth matched interferometers 115, 116, 117 and 118 are coupled together in first and second 4×4 couplers 123, 124 to provide eight outputs 125, 126, 127, 128, 129, 130, 131, 132 each of which contains a substantially equal contribution of the optical radiation from each of the first, second, third and fourth matched interferometers 115, 116, 117 and 118.

Each of the eight outputs 125 to 132 is coupled into a separate sensing subsystem 180. The sensing subsystems 180 each comprise a first and a second sensor array 133, 134, a 2×2 optical fiber coupler 135, and a readout electronics 160. The optical fiber coupler 135 couples the respective outputs 125 to 132 to their respective first and second sensor arrays 133, 134 and couples the returned optical signals from the first and second sensor arrays 133 and 134 to the read-out electronics 160.

Each of the sensing subsystems 180 contain first sensing interferometers 136, second sensing interferometers 137, third sensing interferometers 138, and fourth sensing interferometers 139. It should also be understood that the first and the second sensing interferometers may be located in different subarrays. The optical path length difference in the first sensing interferometers 136 is equal to the optical path length difference in the first matched interferometer 115, the optical path length difference in the second sensing interferometers 137 is equal to the optical path length difference in the second matched interferometer 116, the optical path length difference in the third sensing interferometers 138 is equal to the optical path length difference in the third matched interferometer 117, and the optical path length difference in the fourth sensing interferometers 139 is equal to the optical path length difference in the fourth matched interferometer 118.

The first, second, third and fourth sensing interferometers 136 to 139 are shared between first and second sensing arrays 133, 134 such that sensing interferometers which return optical interference signals to the detector 4 at the same wavelength are not located in the same sensing array.

It is preferred that the path length differences in the first, second, third and fourth matched interferometers 115, 116, 117 and 118 are different from each other by an amount much greater than the coherence length of the optical interference signals returned by the first, second, third and fourth sensing interferometers 136, 137, 138 and 139. Achieving this condition will reduce cross-coupling between first, second, third and fourth sensing interferometers 136, 137, 138 and 139.

The first, second, third and fourth matched interferometers 115, 116, 117 and 118 contain first, second, third and fourth frequency shifters 119, 120, 121 and 122 driven with different frequencies.

The apparatus can be operated such that a single interferometer from each of the first, second, third and fourth sensing interferometers 136, 137, 138, 139 can be interrogated simultaneously, the signals being separated in the electronics by electronic filtration in first, second, third and fourth filters 140, 141, 142, 143 followed by demodulation in the first, second, third and fourth demodulators 144, 145, 146, 147, the filtration and demodulation being carried out with respect to the signals which drive the first, second, third and fourth frequency shifters 119, 120, 121, 122 respectively. It is important to ensure that the frequency shifts induced by the first, second, third and fourth frequency shifters 119, 120, 121 and 122 are sufficiently different that the signals output by the detector 4 resulting from the optical interference signals from the first, second, third and fourth sensing interferometers 136, 137, 138 and 139 can be separated in the frequency domain.

It is important to note that there are restrictions in the operation of the readout electronics 160 which result from the interaction of the frequency at which individual interferometric sensors are sampled and the bandwidth of the filters 140 to 143. These restrictions may reduce the frequency at which wavelength channels can be switched from one to another, may increase the measurement noise, and may increase the cross-coupling between measurement channels.

The optical isolators 41 may not be necessary if isolators are already incorporated into the design of the erbium doped fiber amplifiers 113.

In use, the first and second acousto optic tunable filters 81 and 82 in the first wavelength-switching gain block 221 are tuned so as to interrogate each of the first sensing interferometers 136 sequentially. The first and second acousto-optic tunable filters 81 and 82 in the second, third and fourth wavelength-switching gain block 222, 223 and 224 may be tuned to interrogate the second, third and fourth sensing interferometers 137, 138 and 139 respectively.

Although the first sensing interferometers can be interrogated sequentially, one may advantageously interrogate them randomly or pseudo-randomly to reduce cross-coupling between individual hydrophones. This is particularly advantageous when resulting signals in a seismic survey are “stacked”, since such a (pseudo) random interrogation will lead to incoherent addition of the cross-couplings from different sensors which reduces cross-coupling effects.

It may be desirable to minimize transients in the detected signal from the detector 4 when demodulating individual channels. These transients can result from electronic switching transients and also from optical power transients which occur when one of the acousto-optic tunable filters is switched to a new channel. The electronic switching transients can be controlled by ensuring that all of the acousto-optical tunable filters 81, 82 are switched to new channels simultaneously. The effect of the resulting optical power transients may be reduced by ensuring that the returned optical signals from the respective sensing interferometers arrive at the detector 4 at the same time. The apparatus in FIG. 11 includes a delay coil 171 which may be constructed from optical fiber and is an optional feature. At least one delay coil 171 may be inserted into a convenient position within the apparatus in order to set the timing of returned optical interference signals to the detector 4.

It may be desirable to adjust the wavelengths selected by the first and second acousto-optical tunable filters 81 and 82 to ensure that they coincide with the wavelengths returned by the first, second, third and fourth sensing interferometers 136, 137, 138 and 139. This can be achieved by scanning the wavelengths transmitted by the first and second acousto-optical tunable filters 81 and 82 and determining the position of maximum received signals in each readout electronics 160. Greater measurement accuracy may be achievable by modulating the wavelength transmitted by the first and second acousto-optical tunable filters 81 and 82 and using phase-sensitive detection to provide a control signal to servo onto each center wavelength. It should be noted that the wavelength reflected by optical fiber Bragg gratings are sensitive to measurands such as temperature and strain—hence the apparatus is a distributed temperature and strain sensor when used in this mode.

Thus, this feature of the present invention offers a method of characterizing a seismic streamer system which includes multiple optical fiber Bragg gratings, in that the wavelength of the source may be tuned and the light returned from the Bragg grating monitored to ensure that the returned light falls within prescribed limits.

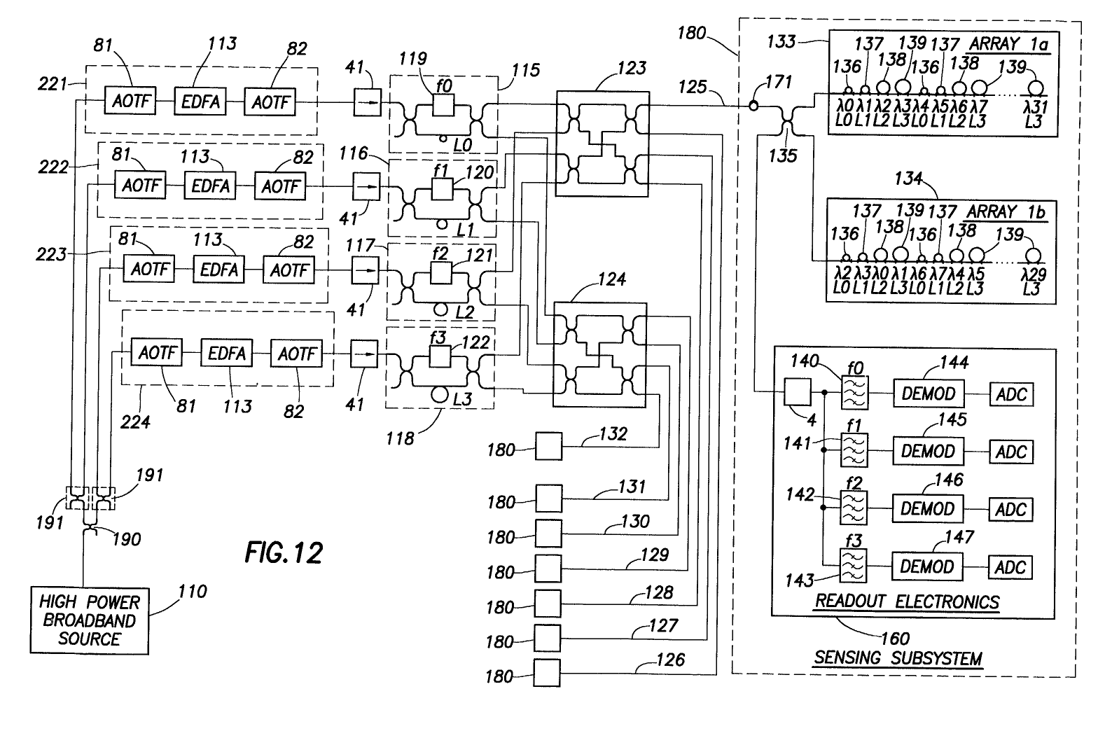

If the high-power broadband source 110 emits unpolarized light, then the splitter 111 may preferably be implemented as shown in FIG. 12 with a 2×2 coupler 190 and two polarization beam splitters 191. This is because typical acousto-optic tunable filters have a preferential transmission for one state of polarization. The coupler 190 and the polarization beam splitters 191 may be constructed with optical fiber.

The apparatus shown in FIG. 11 can be implemented using the following commercially available components: a broadband optical source which emits unpolarized optical power with a spectral density greater than 100 mW/nm over a spectral range of around 40 nm; acousto-optic tunable filters with optical bandwidths of 1 nm to 1.5 nm; and Erbium doped fiber amplifiers with an optical gain of between 20 dB and 30 dB.

The optical power is sufficient to achieve the required signal to noise ratio for seismic streamers based on optical fiber hydrophones. Each optical fiber within the seismic streamer could contain 32 hydrophones, each with approximately 1 nm channel width.

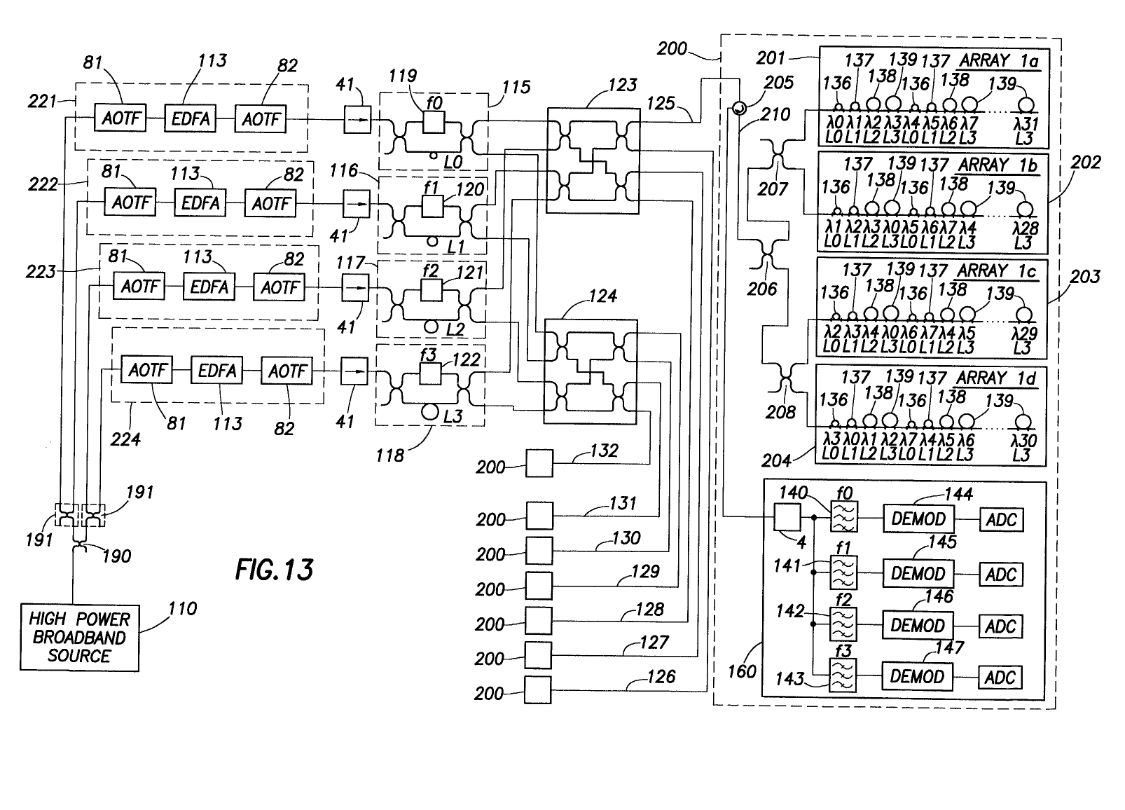

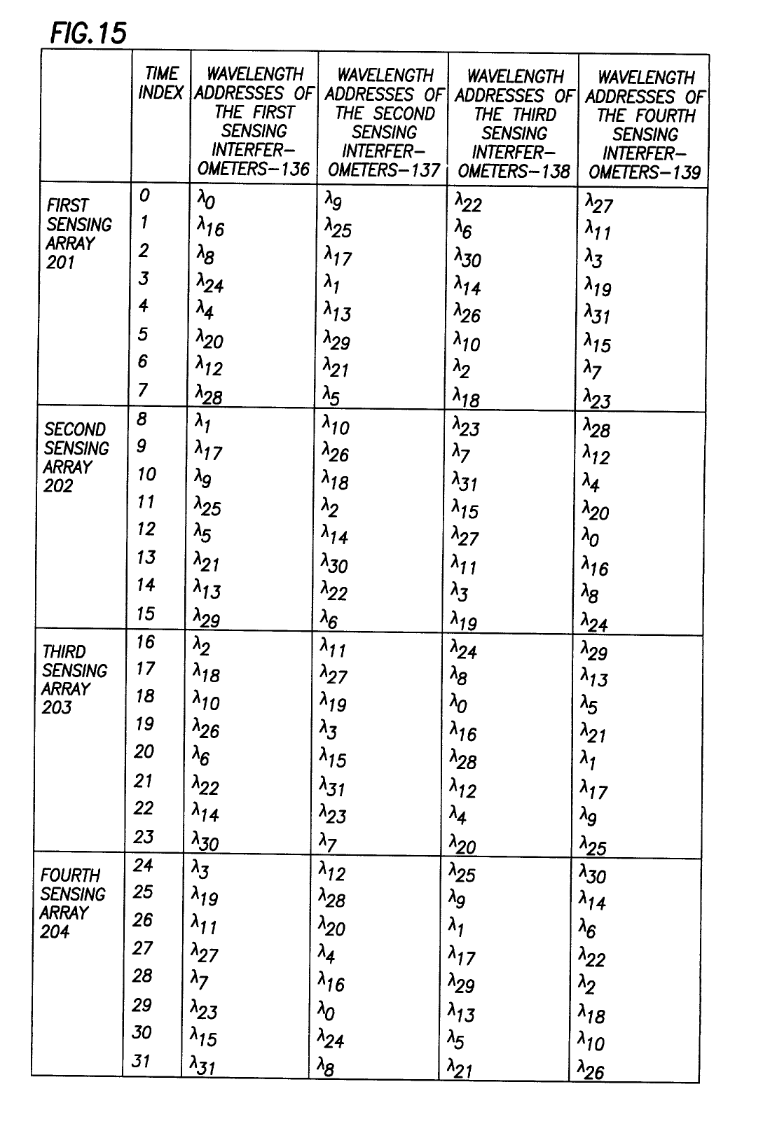

An embodiment which achieves even greater multiplexing efficiency is shown in FIG. 13. The apparatus contains 8 sensing subsystems 200 each of which contains first, second, third and fourth sensing arrays 201, 202, 203, 204, first, second and third optical fiber couplers 206, 207 and 208, an optical fiber 210 and an optical circulator 205.

The optical circulator 205 directs the optical power to the first, second, third and fourth sensing arrays 201, 202, 203, 204 via the optical fiber 210 and directs the returned signals to the readout electronics 160. Use of the optical circulator 205 reduces the overall optical loss in the apparatus.

Each of the sensing subsystems 200 contains first sensing interferometers 136, second sensing interferometers 137, third sensing interferometers 138, and fourth sensing interferometers 139 . The optical path length difference in the first sensing interferometers 136 is equal to the optical path length difference in the first matched interferometer 115 to within the coherence length of the returned optical power from each of the first sensing interferometers 136, the optical path length difference in the second sensing interferometers 137 is equal to the optical path length difference in the second matched interferometer 116 to within the coherence length of the returned optical power from each of the second sensing interferometers 137, the optical path length difference in the third sensing interferometers 138 is equal to the optical path length difference in the third matched interferometer 117 to within the coherence length of the returned optical power from each of the third sensing interferometers 138, and the optical path length difference in the fourth sensing interferometers 139 is equal to the optical path length difference in the fourth matched interferometer 118 to within the coherence length of the returned optical power from each of the fourth sensing interferometers 139.

The sensing subsystem 200 may be such that no two sensing interferometers operate at the same wavelength in any one of the first, second, third and fourth sensing arrays 201, 202, 203 and 204. This feature reduces cross-talk which could occur with multiple reflections between sensing interferometers operating at the same wavelength.

FIG. 14 shows how the sensing subsystem 200 may be used. The optical fiber 210 between the optical circulator 205 and the first optical fiber coupler 206 may be many kilometers long. The arrays from several sensing subsystems 200 may be used in a single cable to form an essentially linear sensor cable. This is advantageous in seismic streamers because it reduces the number of fiber cables within the seismic streamer and therefore reduces the number of fiber to fiber connections in each joint between streamer sections. The apparatus shown in FIG. 14 has four sets of 32 hydrophones per optical fiber 210. It may be advantageous to include optical fiber delays within the sensing arrays in order to adjust the arrival times of optical signals returning from the sensing arrays.

FIG. 15 shows a preferred timing sequence for interrogating the individual sensing interferometers within the apparatus shown in FIG. 13. Time is indicated by the time index number. The vertical columns show the wavelength addresses of the first, second, third and fourth sensing interferometers 136, 137, 138 and 139 which are selected by the first, second, third and fourth wavelength switching gain blocks 221, 222, 223, 224 respectively. These wavelength channels are in ascending wavelength order i.e. 0, 1, 2, 3, 4 etc. The first, second, third and fourth sensing interferometers 136, 137, 138 and 139 are grouped together in the first, second, third and fourth sensing arrays 201, 202, 203, 204 as indicated in FIG. 15. It is preferred that the first, second, third and fourth sensing interferometers 136, 137, 138, 139 are physically located along the sensing arrays in a consistent order. For example, the physical location may be in the order defined in FIG. 15 going from left to right and then top to bottom i.e. (0, (9, (22, (27, (16, (25, (6, (11 etc. The wavelength channels are selected in groups of four at a time. Successive groups of four are selected in the order given by the time index number, which is cycled repeatedly from top to bottom.

The arrangement in FIG. 15 is preferred because sensing interferometers with adjacent channel addresses within the same sensing array are interrogated by different matched interferometers thus reducing cross-coupling within each sensing array. Cross-coupling between sensing interferometers with adjacent channel addresses interrogated by the same matched interferometer can be reduced in the time domain by arranging that cross-coupled signals appear at the detector at different times. These cross-coupled signals can therefore be rejected by blanking (i.e. not sampling the optical signal when the cross-coupled power arrives at the detector 4) or by changing the frequency shift induced by the frequency shifter within the respective matched interferometer so that the cross-coupling can be rejected electronically in the demodulation process.

One may also prefer to order the channels in ascending wavelength order to reduce the effects of unwanted out-of-band reflections which are often at a higher level at shorter wavelengths than at longer wavelengths in typical Bragg gratings.

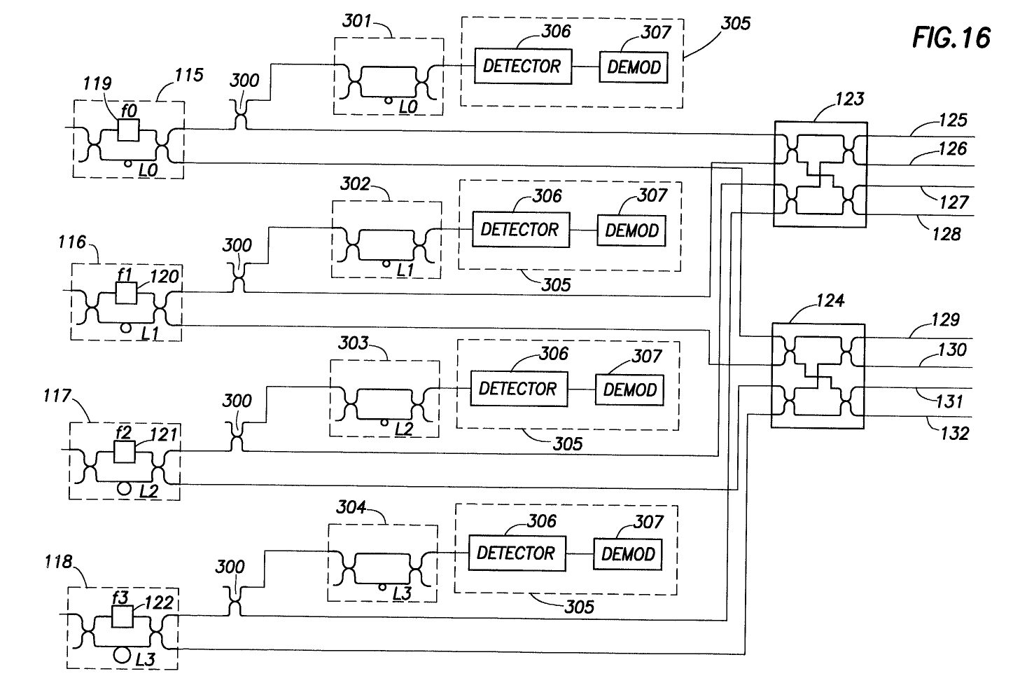

It may be preferable in the apparatus shown in FIGS. 11 to 13 to tap off a small amount of optical power from each of the first, second, third and fourth matched interferometers 115, 116, 117 and 118 with fiber couplers 300, as shown in FIG. 16. The optical radiation is then passed through first, second, third and fourth reference interferometers 301, 302, 303 and 304 having the same optical path length differences as the first, second, third and fourth matched interferometers 115, 116, 117 and 118 respectively. The resulting optical signals are passed to reference readout electronics 305 each containing a detector 306 and demodulator 307. The detected signals are demodulated with respect to the frequency shift induced in the respective matched interferometer in order to generate reference phase signals. These reference phase signals will contain a measure of the source noise which can thus be subtracted from the resulting signals derived from each of the readout electronics 160 in the sensing subsystems 180.

Additional first sensing interferometers, additional second sensing interferometers, additional third sensing interferometers and additional fourth sensing interferometers may be incorporated into the apparatus shown in FIG. 13 and the signals from the additional sensing interferometers and the sensing interferometers operating in the same wavelength channels may be separated in the time domain using time division multiplexing. These additional sensing interferometers may be incorporated into the first, second, third and fourth sensing arrays 201, 202, 203, 204, or implemented in additional sensing arrays.

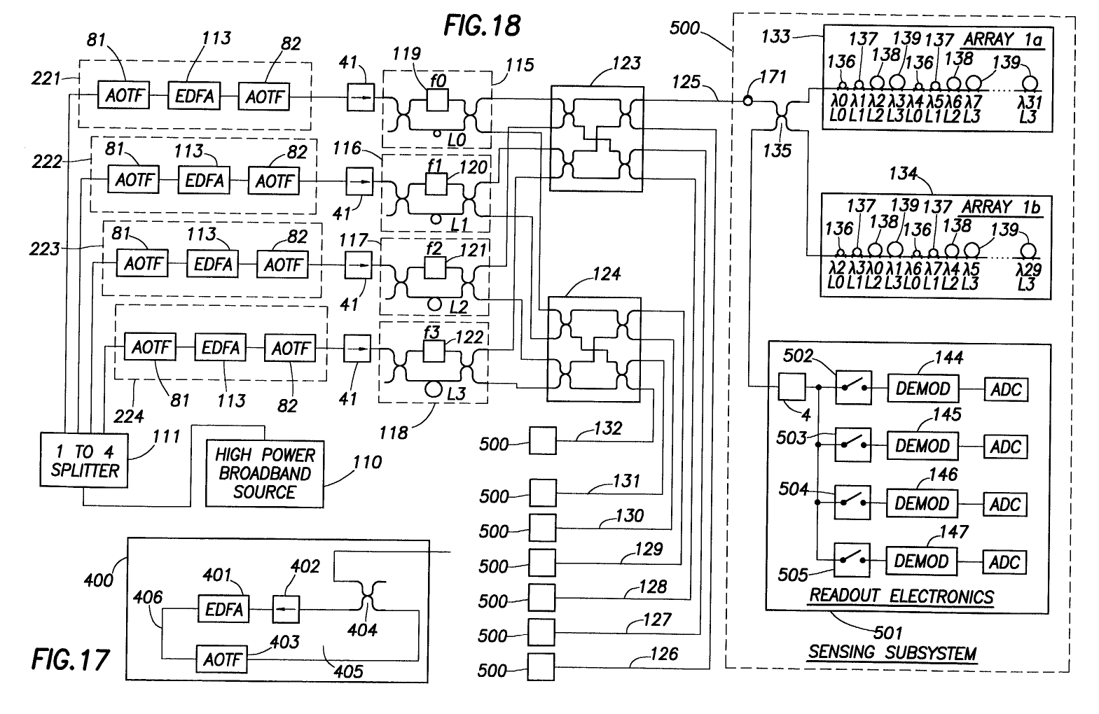

FIG. 17 shows a broadband switched optical source 400 comprising an erbium doped fiber amplifier 401, an optical isolator 402, an acousto-optic tunable filter 403 and a coupler 404 connected together with optical fiber 406 to form a ring 405. The switched optical broadband source 400 will emit broadband light over a spectral range governed by the filtering properties of the acousto-optical tunable filter 403 and the line-narrowing in the erbium doped fiber amplifier 401. Care needs to be taken to ensure that the broadband switched optical source 400 does not lase or generate pulses of optical radiation. This can be achieved by reducing the optical power which circulates around the, ring 405 by increase the proportion of optical power coupled out of the ring 405 by the coupler 404. The broadband switched optical source 400 may be operated in a resonant mode by tuning the passband of the acousto-optic tunable filter 403 such that it tracks the frequency shift of the optical radiation transmitted around the ring 405. The broadband switched optical source 400 can be designed to have a spectral width which is narrower than the broadband switched optical source 100 thus facilitating more wavelength channels to be incorporated into the apparatus. Polarization controllers may be added to the ring 405. The potential disadvantage of this approach for certain applications is that source noise will increase as the spectral width reduces.

The limitations arising from the use of the readout electronics 160 are reduced in the apparatus shown in FIG. 18 by using sensing subsystem 500 containing readout electronics 501. The filters 140 have been replaced by first, second, third and fourth switches 502, 503, 504 and 505. Although not strictly necessary, the first, second, third and fourth switches 502-505 can gate the signals output by the detector in order to remove transients and/or separate signals in the time domain. The apparatus may be operated such that signals returning from the first sensing interferometers 136 are gated by the first switch 502 and demodulated by the first demodulator 144, the signals returning from the second sensing interferometers 137 are gated by the second switch 503 and demodulated by the second demodulator 145, the signals returning from the third sensing interferometers 138 are gated by the third switch 504 and demodulated by the third demodulator 146, and the signals returning from the fourth sensing interferometers 139 are gated by the fourth switch 505 and demodulated by the fourth demodulator 147. In this manner, it is possible to separate the interrogation of the first, second, third and fourth sensing interferometers 136-139 in the time domain which may help to reduce cross-coupling between channels. Separating channels in this way provides simplicity in the overall system architecture, but is not strictly necessary. For example, the first, second, third and fourth demodulators 144-147 could address individual sensing interferometers randomly in time with the signals from individual sensing interferometers reconstructed downstream in processing electronics.

Depending on the system performance requirements and the performance of the first, second, third and fourth demodulators 144 to 147, the apparatus may be operated without the first, second, third and fourth switches 502-505.

It should also be noted that if the sampling frequency at which any one sensing interferometers is sampled is very much greater than the frequency shift induced by the first, second, third or fourth frequency shifters 119 to 122, then the output from the detector 4 can be digitized directly by an analog to digital converter and the demodulation carried out using signal processing. This is also true for the more general case where the first, second, third and fourth frequency shifters are replaced by phase modulators and the sampling frequency is very much greater (for example a factor of four to eight times, but preferably twelve times or higher) than the modulation frequency applied by the phase modulators.

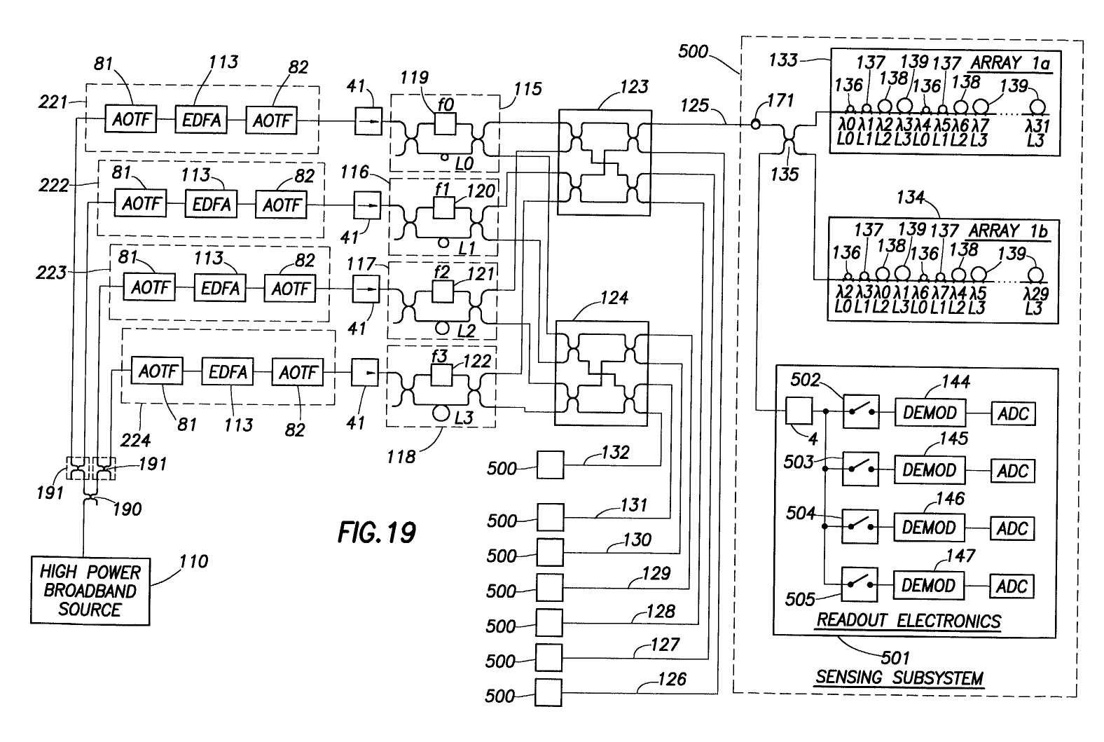

The readout electronics 501 may also be used in the apparatus in FIG. 12, as shown in FIG. 19, with the same advantages.

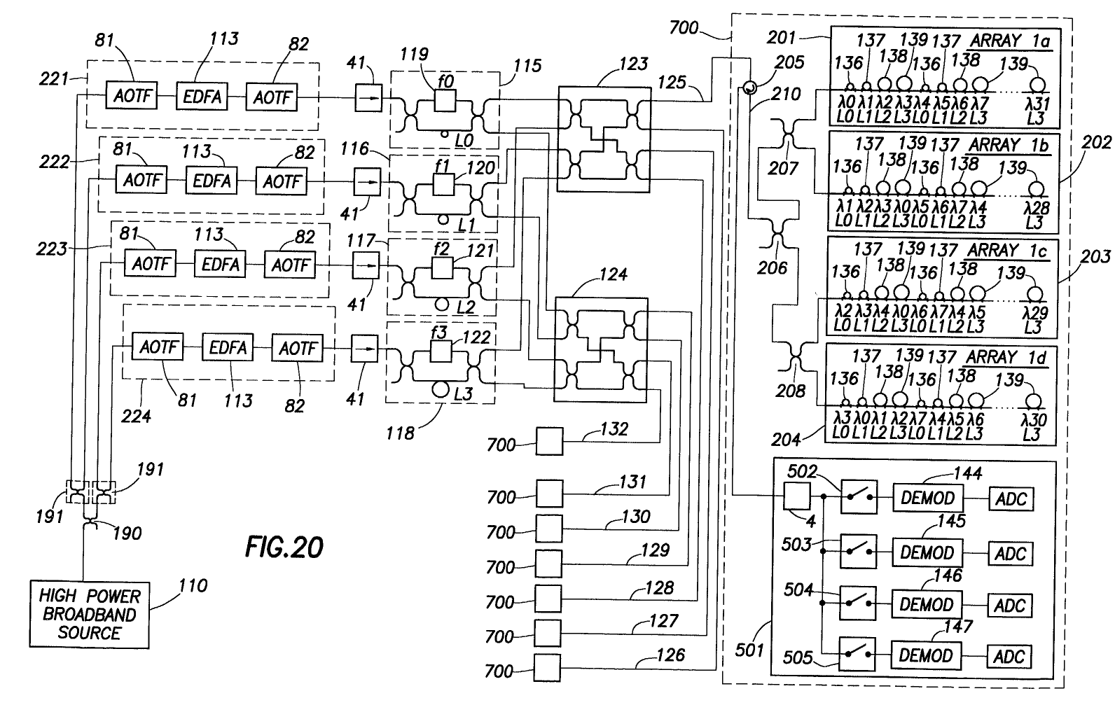

FIG. 20 shows the readout electronics 501 being used in the sensing subsystem 700.

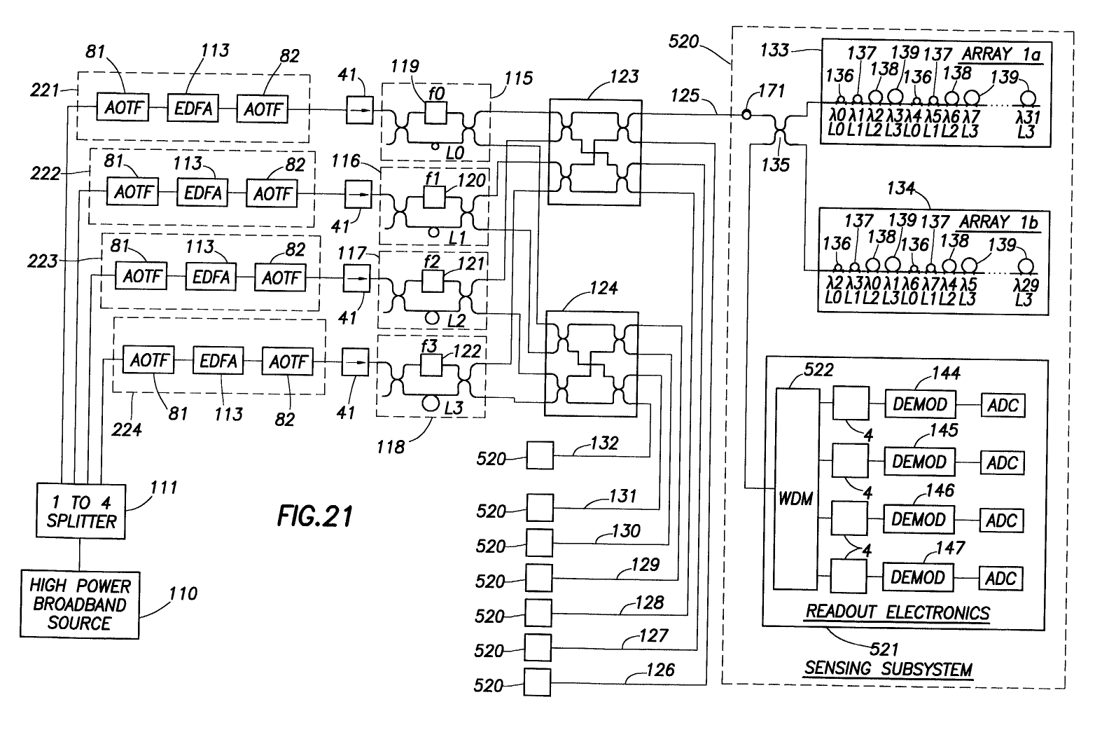

FIG. 21 shows the use of a wavelength division multiplexer 522 in readout electronics 521 in a sensing subsystem 520 in order to simplify the electronic frequency spectrum incident on the first, second, third and fourth demodulators 144 to 147 and thereby to improve the performance of the overall system.

The wavelength division multiplexer 522 may utilize a blazed grating, or may be constructed from optical fiber gratings and optical circulators.

If passive wavelength division multiplexing is employed, and if the first, second, third and fourth sensing interferometers 136-139 operate over similar wavelength bands, then the first, second, third and fourth demodulators 144 to 147 will need to demodulate signals returning from each of the first, second, third and fourth sensing interferometers at different times.

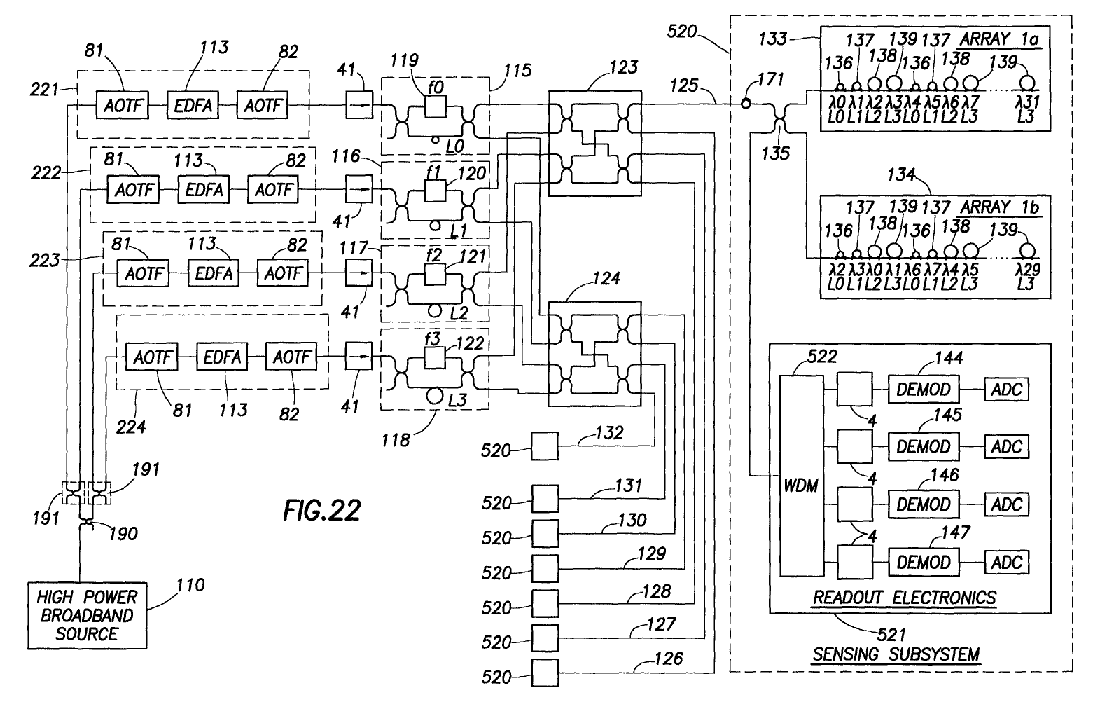

FIG. 22 shows the sensing subsystem 520 being employed in an apparatus containing polarization beam splitters 191.

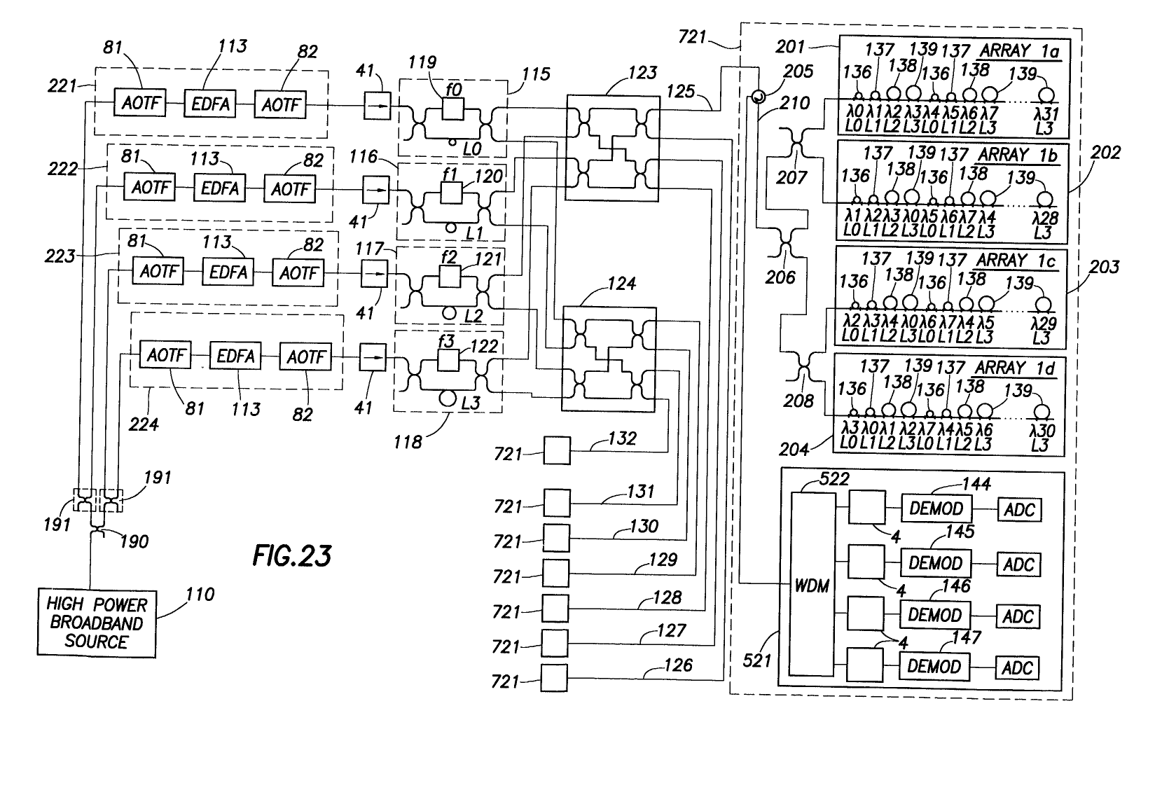

FIG. 23 shows the wavelength division multiplexer 522 being used in sensing subsystem 720 containing readout electronics 521.

Active wavelength division multiplexing may also be employed using, for example, acousto-optic tunable filters.

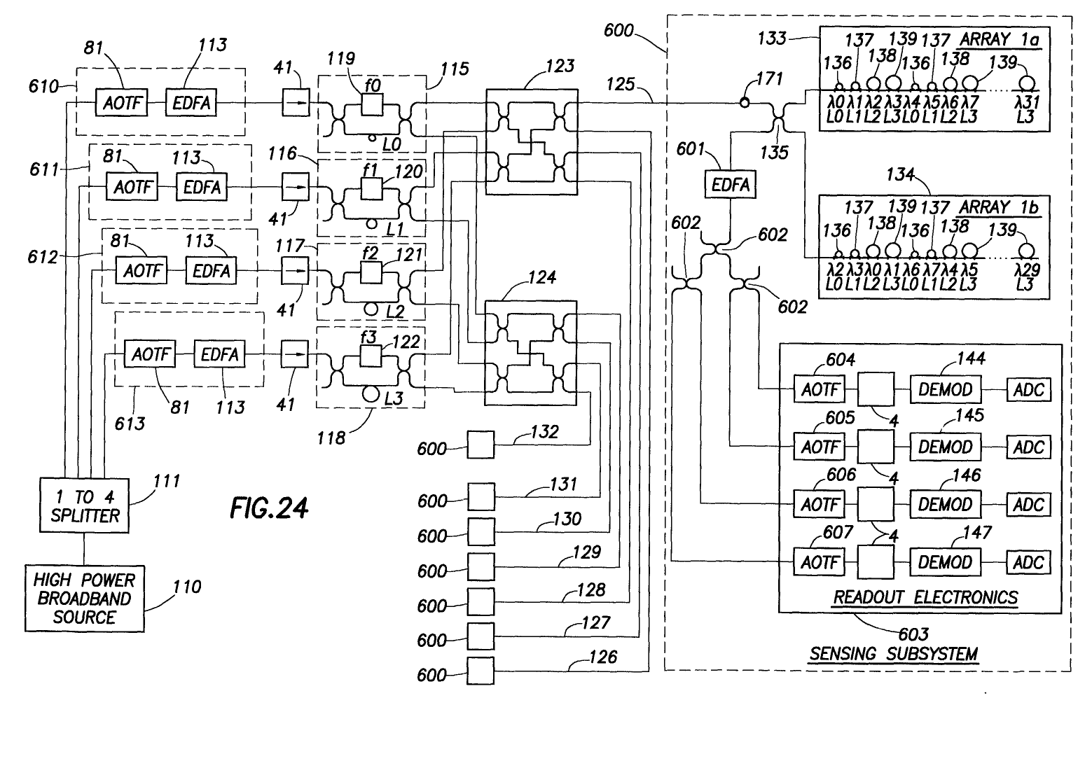

FIG. 24 shows a preferred embodiment of the invention. The sensing subsystem 600 contains an optical amplifier 601, optical fiber couplers 602 and readout electronics 603. The optical amplifier 601 amplifies the returning signals from the first and second sensing arrays 133 and 134 and the amplified signals are divided by the optical fiber couplers 602 and filtered by first, second, third and fourth acousto-optical tunable filters 604-607.

The filtered signals are detected by the detector 4 and demodulated by first, second, third and fourth demodulators 144-147. It is important that the first, second, third and fourth acousto-optical tunable filters 604 select the correct wavelength channel and that the first, second, third and fourth demodulators 144-147 are referenced to the frequency shift applied by the correct first, second, third or fourth frequency shifters 119 to 122.

The acousto-optic tunable filters 604 to 607 may be implemented with the same characteristics as the second acousto-optic tunable filters 82 in order to reduce cross-coupling between channels.

Source noise may be reduced by incorporating the apparatus shown in FIG. 16.

The first, second, third and fourth wavelength-switching gain blocks 610-613 are shown without the second acousto-optic tunable filters 82, but improved performance may be gained using them.

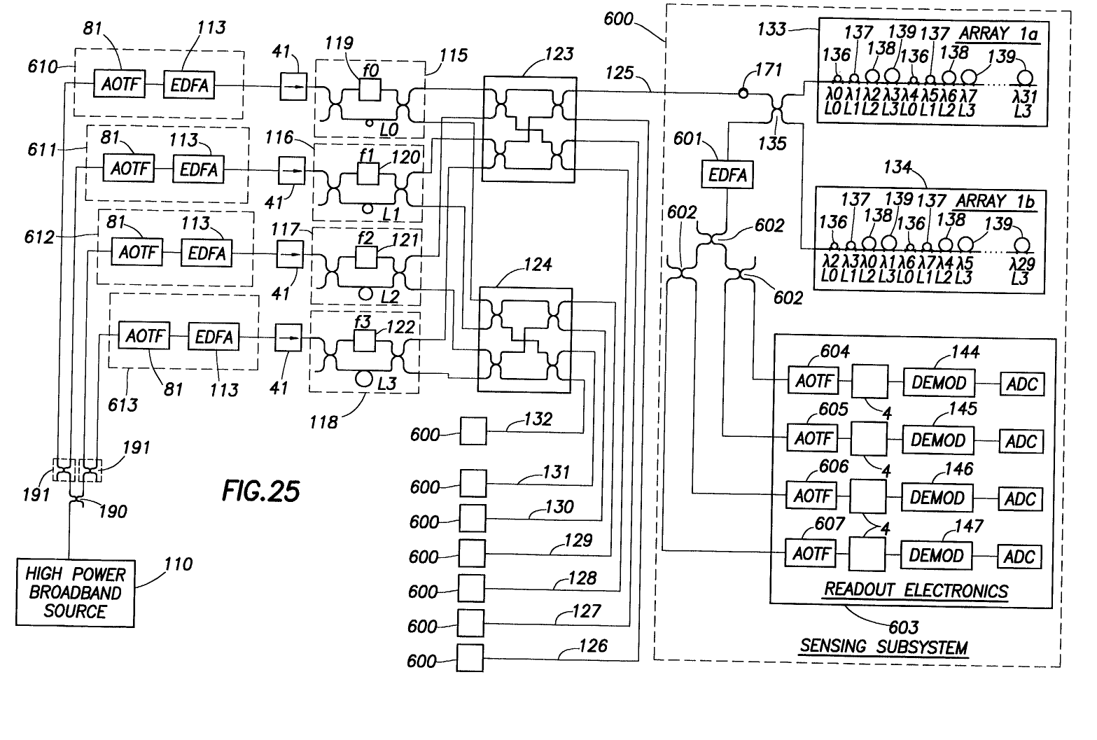

FIG. 25 shows the sensing subsystem 600 being employed in an apparatus containing polarization beam splitters 191.

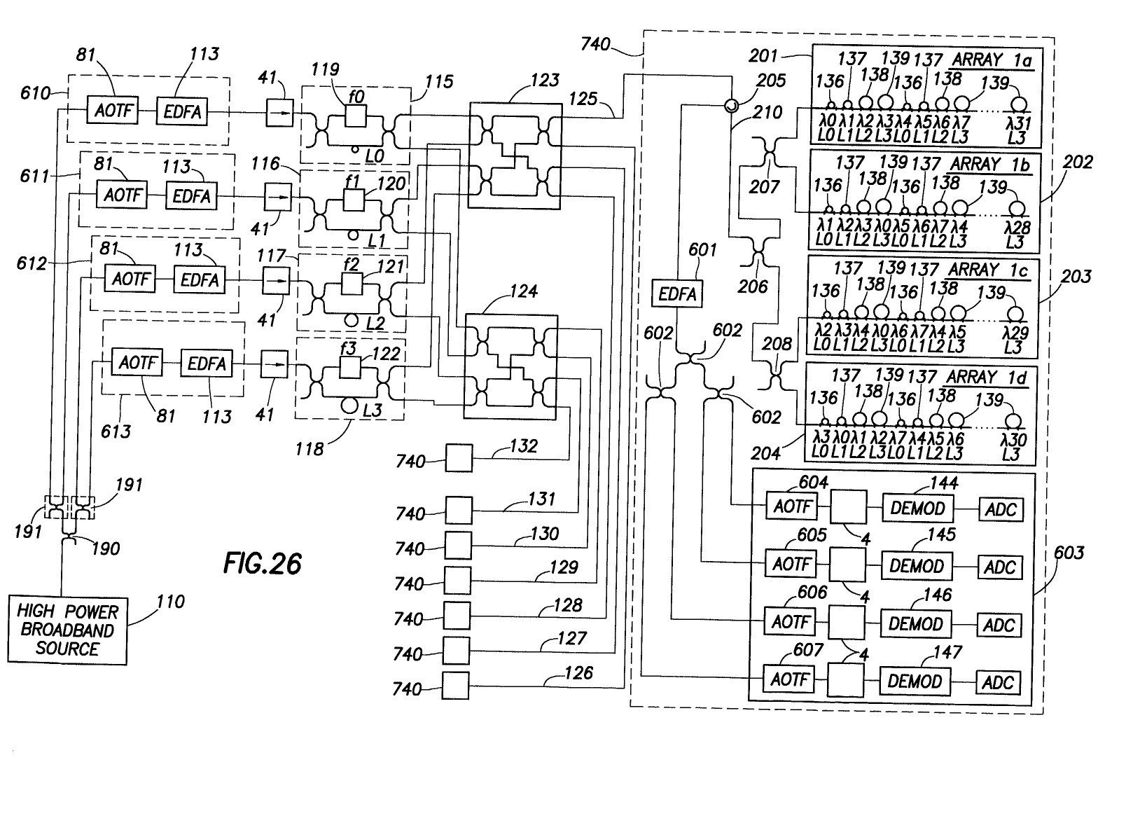

FIG. 26 shows a preferred embodiment of the invention. A sensing subsystem 740 utilizes the readout electronics 603 which is believed to be particularly advantageous for application in the oil and gas industry for seismic surveys.

A particular advantage of the use of the acousto-optic tunable filters is that they can help reject cross-talk between individual interferometric sensors arising from non-linear effects such as Raman scattering in the system. Cross-coupling may also be reduced by varying the modulation frequencies applied by the frequency shifters within the respective matched interferometer so that the cross-coupling can be rejected electronically in the demodulation process.

If the sampling frequency for each of the sensing interferometers is much greater than the modulation frequency induced by the first, second, third and fourth frequency shifters 119 to 122, then the outputs from the detectors 4 may be digitized directly with an analog to digital converter and the signals demodulated in a signal processor.

If the sampling frequency for each of the sensing interferometers is much less than the modulation frequency induced by the first, second, third, and fourth frequency shifters 119-122, then the outputs from the detectors 4 may be frequency shifted using radiofrequency (RF) mixers prior to digitization and demodulation in a signal processor. Analogous techniques are currently employed in digital radios.

Although the embodiments shown in FIGS. 11, 12, 13, and 18-26 depict a plurality of wavelength switching gain blocks, such as for example 221, 222, 223 and 224, the present invention can be implemented using a single wavelength switching gain block whose output light is coupled into a plurality of matched interferometers each having a unique optical path length difference and a unique modulation signal applied to their respective phase modulators. It would then be important to ensure that the signals returning at the same wavelength from each of the corresponding sensing interferometers (i.e., those matched to their respective matched interferometers) are separated effectively at the detector. This can be achieved by ensuring that each sensing interferometer operating at the same wavelength is located at the same distance away from the source such that the optical signals return simultaneously. Alternatively, the sensing interferometers operating at the same wavelength could be located at different distances away from the source such that the returning signals at the same wavelength are separated in time.

It is to be appreciated that the embodiments of the invention described above with reference to the accompanying drawings have been given by way of example only and that modification and additional components may be provided to enhance the performance of the apparatus.

We claim:

1. Apparatus for interferometric sensing which apparatus comprises a first broadband switched optical source, a first matched interferometer, a plurality of first sensing interferometers, and a detector:
the first matched interferometer being such that it contains a first phase modulator;
the apparatus being such that the optical path length difference in each of the first sensing interferometers is approximately equal to the optical path length difference in the first matched interferometer;
the first sensing interferometers being such that each returns an optical interference signal to the detector at a substantially different wavelength; and
the apparatus being such that the first broadband switched optical source is switched so as to emit optical radiation at wavelengths corresponding to each of the first sensing interferometers at different times.

2. Apparatus according to claim 1 in which the first phase modulator is a frequency shifter.

3. Apparatus according to claim 1 wherein at least one of the first sensing interferometers is a fiber optic sensing interferometer containing at least one optical fiber Bragg grating.

4. Apparatus according to claim 3 in which the fiber optic sensing interferometer contains an optical fiber Bragg grating at each end of the fiber optic sensing interferometer, with the optical fiber Bragg gratings chirped in opposite directions.

5. Apparatus according to claim 1 wherein at least one of the first sensing interferometers is an optical fiber hydrophone.

6. Apparatus according to claim 5 in which the optical fiber hydrophone is constructed from an optical fiber twisted around a compliant member and bonded.

7. Apparatus according to claim 1 wherein the apparatus contains at least one depolarizer.

8. Apparatus according to claim 1 wherein the apparatus contains an optical circulator to direct optical radiation to the first sensing interferometers and to direct light returning from the first sensing interferometers to the detector.

9. Apparatus according to claim 1 further comprising an optical isolator to isolate the first broadband switched optical source from reflections.

10. Apparatus according to claim 1 further comprising an optical amplifier to improve signal to noise ratio.

11. Apparatus according to claim 1 wherein the apparatus contains an additional first sensing interferometer which reflects at substantially the same wavelength as one of the first sensing interferometers and where the path length difference in the additional first sensing interferometer is approximately equal to the path length difference in the first matched interferometer, the apparatus being such that the optical interference signals from the additional first sensing interferometer is not incident on the detector at the same time as the optical interference signal returning from any of the first sensing interferometers.

12. Apparatus according to claim 1 wherein the first broadband switched optical source contains at least one acousto-optic tunable filter.

13. Apparatus according to claim 12 further comprising first and second acousto-optic tunable filters, in which the first acousto-optic tunable filter has its first wavelength zeros substantially at the wavelength corresponding to the first sidebands of the second acousto-optic tunable filter.

14. Apparatus according to claim 1 wherein the apparatus includes a second matched interferometer, a first coupler, a second coupler, and a plurality of second sensing interferometers:
the first coupler being such that it directs optical radiation from the first broadband switched optical source to both the first and the second matched interferometers;
the second matched interferometer being such that it contains a second phase modulator, the second matched interferometer further defining a second optical path length difference which is different from the optical path length difference in the first matched interferometer;
the second coupler being such that it combines light from the first matched interferometer and the second matched interferometer and directs the light into an array of the first and second sensing interferometers; and
the apparatus being such that the phase modulation applied by the first phase modulator is different than the modulation applied by the second phase modulator.

15. Apparatus according to claim 14 wherein the first and the second sensing interferometers are located in different sub arrays.

16. Apparatus according to claim 1, wherein the apparatus contains a second broadband switched optical source, a second matched interferometer, a coupler, and a plurality of second sensing interferometers, with the second matched interferometer connected to the second broadband switched optical source, the second matched interferometer containing a second phase modulator, the coupler being such that it combines light from the first matched interferometer and the second matched interferometer and directs the combined light to the sensing arrays, the apparatus being such that the optical path length difference in the second sensing interferometers is approximately equal to the optical path length difference in the second matched interferometer, the second sensing interferometers being such that each returns an optical interference signal to the detector at a different wavelength, and the apparatus being such that the second broadband switched optical source is switched so as to emit optical radiation at wavelengths corresponding to each of the second sensing interferometers at different times.

17. Apparatus according to claim 16 wherein the coupler directs light returning from the first and second sensing interferometers to a detector.

18. Apparatus according to claim 16 in which the differences in the path length difference in the first matched interferometer and the second matched interferometer is greater that the coherence length of the light which is returned to the detector.
